(19) United States
(12) Patent Application Publication
(10) Pub. No.: US 2025/0269341 A1
(43) Pub. Date: Aug. 28, 2025

(54) SYSTEM AND METHOD FOR THE UNLOADING AND INERTIZATION OF TANKS USED IN A PHYSICAL, CHEMICAL AND/OR BIOLOGICAL PROCESS

(71) Applicant: DYNAMIC AIR LTDA, Sao Paulo (BR)

(72) Inventors: Horacio N. Paez, Sao Paulo (BR); Gregory J. Steele, Saint Paul, MN (US)

(73) Assignee: DYNAMIC AIR LTDA, Sao Paulo (BR)

(21) Appl. No.: 19/061,531

(22) Filed: Feb. 24, 2025

(30) Foreign Application Priority Data
Feb. 26, 2024 (BR) 1020240036875

(51) Int. Cl. B01J 4/00; B01J 2/10; B01J 8/00; B01J 8/18

(52) U.S. Cl. CPC B01J 4/002; B01J 2/10; B01J 8/004; B01J 8/1818; B01J 2204/005

(57) ABSTRACT

The present invention relates to a system, method, and use for the unloading of solid material particles used in a physical, chemical, and/or biological process in a tank and for the inertization of the tank. The receiving tank and the pump are fluidically connected. The inert gas supply device is fluidically connected to the tank and to at least one injector. The at least one injector is arranged along the transport line that connects the tank to the receiving tank and is configured to inject inert gas into the transport line. The pump is configured to generate negative pressure in the receiving tank and in the tank, and the inert gas supply device is configured to insert inert gas into the tank and supply inert gas to at least one injector, to allow the displacement of solid material particles from the tank to the receiving tank.

### TECHNICAL FIELD

The present invention relates to the unloading of tanks. More particularly, the present invention relates to a pneumatic system and method for the unloading of solid material associated with a physical, chemical, or biological process in a tank, and for the inertization of the tank.

### PRIOR ART

Tanks are commonly used for the storage and transport of products in general. Tanks, typically metallic or made of composite material, can also be used as vessels within which some physical, chemical, or biological process occurs. To carry out and control such processes, agents of different natures may be employed, such as chemical agents, catalysts, and adsorbents. For example, when a chemical or biological reaction occurs, a tank assumes the role of a reactor, and some type of catalyst is employed inside it.

Reactors are important equipment for performing and controlling chemical and/or biological reactions on an industrial or laboratory scale. Reactors are designed to provide ideal conditions for chemical substances to react and form desired products. They play a crucial role in various sectors, such as the chemical, pharmaceutical, food, and materials industries. There are several types of reactors, each suitable for different types of processes. Some of the most common reactors include batch reactors, continuous reactors, stirred tank reactors, tubular reactors, and fixed-bed reactors. The choice of the type of reactor depends on the characteristics of the reaction, the required conditions, and the objectives of the process. For example, the use of reactors in the oil industry is well known, such as reactors for converting heavy hydrocarbons into lighter ones using catalysts, in so-called catalytic reactors.

The loading and unloading of catalysts in reactors depend on the type of reactor and on the desired process. In the case of fixed-bed reactors, catalysts are typically loaded at the beginning during installation of the reactor. This involves filling the reactor bed with catalyst particles suitable for the desired reaction. In stirred tank reactors, for example, the catalyst can be added directly to the tank or placed in a suspension system. On the other hand, in tubular systems, the catalyst can be placed in a specific section of the tube where the reactants flow. The unloading process in fixed-bed reactors generally occurs during scheduled maintenance shutdowns. The spent or saturated catalyst can be removed from the bed and replaced with a new catalyst. In stirred tank reactors, the catalyst can be removed using methods such as filtration or sedimentation, depending on the nature of the catalyst. Cleaning and replacement of catalyst in tubular systems can be carried out by stopping the flow and replacing the catalyst in the appropriate section.

Alternatively or additionally to the functioning as a reactor, a tank may also contain an agent that plays a filtration role. In this situation, the agent takes the form of an adsorbent, retaining the material to be filtered on its surface. Some agents may simultaneously have the function of a catalyst and an adsorbent.

With use, after a certain number of chemical or biological reactions and/or physical particle separations, the agent begins to lose its efficiency, whether due to saturation, chemical degradation, or loss of permeability, requiring its replacement. Additionally, especially in a situation where the involved agents present some risk of combustion or explosion, the tanks need to be inertized. Typically, the inertization process involves the insertion of inert gases into the tank.

### SUMMARY OF THE INVENTION

The present invention relates to a system for unloading particles of solid material used in a physical, chemical, and/or biological process in a tank and for the inertization of the tank. The system comprises a receiving tank, a pump, an inert gas supply device, and at least one injector. The receiving tank and the pump are fluidically connected. The inert gas supply device is fluidically connected to the tank and to the at least one injector. The receiving tank is fluidically connected to the tank by means of a transport line. The at least one injector is arranged along the transport line that connects the tank to the receiving tank and is configured to inject inert gas into the transport line. The pump is configured to generate negative pressure in the receiving tank and in the tank, and the inert gas supply device is configured to insert inert gas into the tank and supply inert gas to the at least one injector, to allow the displacement of solid material particles from the tank to the receiving tank.

Optionally, the tank is a reactor.

Optionally, the solid material is a catalyst, an adsorbent, or a catalyst and adsorbent.

Optionally, the pump and the receiving tank are fluidically connected by means of a transport line.

Optionally, the receiving tank comprises a level sensor or a weight sensor.

Optionally, the inert gas supply device is fluidically connected to the tank and to the at least one injector by means of ducts.

The present invention is also related to the use of the system as described above for the unloading and inertization of one or more tanks.

The present invention is also related to a method for the unloading of solid material particles used in a physical, chemical, and/or biological process in a tank and for the inertization of the tank by means of a system as described above. The method comprises the steps of: generating negative pressure in the receiving tank and in the tank, and inserting inert gas into the tank and in the transport line that connects the tank and the receiving tank to move solid material particles from the interior of the tank to the interior of the receiving tank.

### BRIEF DESCRIPTION OF THE FIGURES

FIG. 1 illustrates an example of an embodiment of the system according to the present invention.

### DETAILED DESCRIPTION

The following description refers to ducts and transport lines connecting the different components of the system of the present invention. As a person skilled in the art will recognize, the connected components of the system described below must be fluidically connected. However, different configurations to achieve a fluidic connection are possible, such as, for example, the use of multiple lines and ducts between two components and manifolds.

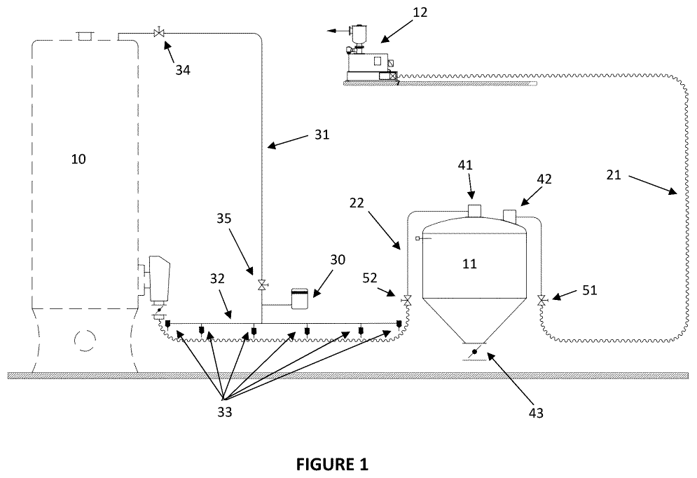

FIG. 1 illustrates an example of an embodiment of a system according to the present invention for unloading a tank 10 containing solid material particles. The system comprises a receiving tank 11, a pump 12, and an inert gas supply device 30. A transport line 21 connects the pump 12 to the receiving tank 11. A transport line 22 connects the receiving tank 11 to the tank 10. The inert gas supply device 30 is connected to the upper part of the tank 10 by a duct 31 and to a series of injectors 33 by a duct 32. The injectors 33 are arranged along the transport line 22.

The concept of vacuum dense-phase pneumatic conveyance known in the prior art is employed to remove solid material particles from inside the tank 10. The pump 12 is activated to suction line 21. At some point, negative pressure will be generated in line 21, in the receiving tank 11, in line 22, and finally, in tank 10.

Additionally, the inert gas supply device 30 is also activated to enable the flow within the system. An inert gas is inserted into the tank 10, which will cause the solid material particles located inside the tank 10 to move into and through the transport line 22, reaching the receiving tank 11. Since line 22 is preferably connected to the upper part of the receiving tank 11, the solid material particles will accumulate, due to centrifugal and gravitational forces and due to the decrease of speed to values below those of pneumatic drag, at the bottom of the receiving tank 11.

Additionally, inert gas is injected along transport line 22 through the injectors 33. This additional injection assists in the pneumatic conveyance of solid material particles from tank 10 to the receiving tank 11.

Examples of inert gases include nitrogen (N₂), carbon dioxide (CO₂), and noble gases such as helium, argon, krypton, xenon, and radon.

Examples of injectors include the pressure/vacuum adjuster and regulator injector, model DC-5, manufactured and marketed by Dynamic Air Ltd.

Valves 34, 35 can be installed in ducts 31, 32 to connect and disconnect the inert gas supply device 30 to/from the system and to regulate the flow of inert gas entering the tank 10 and the injectors 33.

The tank 10 may be a reactor related to a chemical and/or biological process, and the solid material may be any catalyst capable of performing such a chemical and/or biological process. The tank 10 may also be associated with a physical filtration process, and the solid material may be any adsorbent suitable for performing such a filtration process. In some cases, the solid material may perform both catalyst and adsorbent roles.

As any skilled person will recognize, any commercially available vacuum pump or compressor equipment can be used as pump 12. The size and power of pump 12 will depend on each project, such as the type of tank used, the dimensions of the tank, the type and length of the transport lines, and the type of connections used. It is also possible to install more than one pump 12, which may either alternate operation or work together to generate negative pressure in the system of the invention.

Likewise, a skilled person will recognize that known techniques can be applied in the supply of inert gas. For example, the inert gas supply device 30 may be a cylinder containing pressurized gas at a pressure higher than that of the tank 10 and the transport line 22. The inert gas supply device 30 may also comprise a pump responsible for injecting the inert gas into the system. It is also possible to install more than one inert gas supply device 30, which may either alternate operation or work together to supply inert gas to the system of the present invention.

The transport lines 21 and 22 and the ducts 31 and 32 may be rigid, such as metallic pipelines, or flexible, such as rubber hoses. The choice between rigid or flexible lines and ducts, or a combination of both, will also depend on each project and the site of installation of the system of the present invention.

The receiving tank 11 is preferably a metallic tank that will accumulate solid material particles removed from tank 10. The receiving tank 11 preferably has an inlet 41 and an outlet 42 at its upper part. The inlet 41 is connected to the transport line 22, and the outlet 42 is connected to the transport line 21. Preferably, the receiving tank 11 has a conical bottom part to facilitate the subsequent discharge of the accumulated solid material particles through a lower outlet 43.

At some point during the unloading of tank 10, the receiving tank 11 will become full. At this moment, the pump 12 and the inert gas supply device 30 are turned off or disconnected from the system, and valves 51, 52 positioned along lines 21 and 22 are closed, allowing the disconnection of the loaded receiving tank 11 and the connection of a new empty receiving tank 11. The use of inert gas in the tank 10 and in the transport line 22 ensures that the transport of solid material particles occurs in an inert environment, also inertizing the receiving tank 11. Optionally, the receiving tank 11 and the valves 51, 52 are designed to maintain an inert atmosphere inside the loaded receiving tank 11 after its disconnection from the system. The inert gas supply device 30 may also optionally be connected (not illustrated) to an inlet of the receiving tank 11 to insert inert gas into the receiving tank 11.

Once the new receiving tank 11 is connected to the system, valves 51, 52 are reopened, the pump 12 and the inert gas supply device 30 are restarted or reconnected to the system, and the unloading of tank 10, or of a new tank 10, is continued/initiated. Obviously, depending on the project, the volume of solid material to be unloaded from tank 10 may correspond to the volume of the receiving tank 11. As any skilled person will also recognize, although an empty receiving tank 11 has been described for the unloading of tank 10, the receiving tank 11 may be partially empty and still be able to receive solid material particles.

Valves 34, 35, 51, 52, as well as any other valves used throughout the system, may be any commercially available valves known in the prior art, such as a ball valve.

The state of filling of the receiving tank 11 can be manually checked. Alternatively, a weight sensor (not illustrated), such as a scale, can be positioned beneath the receiving tank 11 to verify when its filling reaches a maximum limit. Alternatively, a level sensor can be used inside the receiving tank 11 to detect when its filling reaches a maximum limit.

The level sensor may be any commercially available sensor known in the prior art, such as a hydrostatic level sensor, a capacitive level sensor, or an ultrasonic level sensor.

Thus, the system and method of the present invention enable the unloading of a tank 10 in a simple, efficient, and safe manner. The same inert gas used to facilitate the flow of solid material particles out of tank 10 toward a receiving tank 11 is simultaneously used to inertize the interior of the tank 10 and to assist the conveyance of solid material particles along the transport line 22 connecting tank 10 to the receiving tank 11.

1. A system for the unloading of solid material particles used in a physical, chemical, or biological process in a tank and for the inertization of the tank, comprising:
a receiving tank;
a pump;
an inert gas supply device; and
at least one injector,
wherein:
the receiving tank and the pump are fluidically connected;
the inert gas supply device is fluidically connected to the tank and to at least one injector;
the receiving tank is fluidically connected to the tank by means of a transport line;
the at least one injector is arranged along the transport line and is configured to inject inert gas into the transport line;
the pump is configured to generate negative pressure in the receiving tank and in the tank, and the inert gas supply device is configured to insert inert gas into the tank and supply inert gas to the at least one injector, to allow the displacement of solid material particles from the tank to the receiving tank.

2. The system of claim 1, wherein the tank is a reactor.

3. The system of claim 1, wherein the solid material is a catalyst, an adsorbent, or a catalyst and adsorbent.

4. The system of claim 1, wherein the pump and the receiving tank are fluidically connected by means of a transport line.

5. The system of claim 1, wherein the receiving tank comprises a level sensor or a weight sensor.

6. The system of claim 1, wherein the inert gas supply device is fluidically connected to the tank and to at least one injector by means of ducts.

7. Use of the system as defined in claim 1, for the unloading and inertization of one or more tanks.

8. A method for the unloading of solid material particles used in a physical, chemical, or biological process in a tank and for the inertization of the tank, performed in a system as defined in claim 1 and comprising the steps of:
generating negative pressure in the receiving tank and in the tank; and
inserting inert gas in the tank and in the transport line to move solid material particles from the interior of the tank to the interior of the receiving tank.
